(19) United States
(12) Patent Application Publication
(10) Pub. No.: US 2026/0189602 A1
(43) Pub. Date: Jul. 2, 2026

(54) Security incident ranking and ranking explanation

(71) Applicant: Palo Alto Networks, Inc., Santa Clara, CA (US)

(72) Inventors: Tuvia Newman, Kiryat Gat (IL); Yinnon Meshi, Kibbutz Revivim (IL); Gal Itzhak, Holon (IL); Sharon Datner, Tel Aviv (IL)

(21) Appl. No.: 19/546,465

(22) Filed: Feb. 23, 2026

Related U.S. Application Data
(63) Continuation of application No. 18/357,121, filed on Jul. 23, 2023, now Pat. No. 12,615,282.

(51) Int. Cl. H04L 9/40

(52) U.S. Cl. CPC H04L 63/1441; H04L 63/1416

(57) ABSTRACT

Methods, systems, and computer program products obtain electronically stored records generated by one or more computers and indicative of one or more alerts raised in response to a computer security incident. A processor extracts data informative of one or more of: (i) presence or absence of specific alert types, (ii) a number of different alert types raised in response to the incident, and (iii) a number of times a given alert type or combination of alert types was raised in a specified previous time period, executes a scoring model on the extracted data to generate a maliciousness score for the incident, computes contribution values for portions of the extracted data indicating respective contributions to the maliciousness score, selects a portion having a greatest contribution value, and selects and initiates a protective action of one of isolating a computing device, terminating a process, quarantining a file, or restricting user access.

### CROSS-REFERENCE TO RELATED APPLICATIONS

This application is a continuation of U.S. application Ser. No. 18/357,121, filed Jul. 23, 2023, which is hereby incorporated by reference in its entirety.

### FIELD OF THE INVENTION

The present invention relates generally to computer security, and particularly selecting and performing a protective action upon detecting a malicious incident on a data network.

### BACKGROUND OF THE INVENTION

In many computers and network systems, multiple layers of security apparatus and software are deployed in order to detect and repel the ever-growing range of security threats. At the most basic level, computers use anti-virus software to prevent malicious software from running on the computer. At the network level, intrusion detection and prevention systems analyze and control network traffic to detect and prevent malware from spreading through the network.

The description above is presented as a general overview of related art in this field and should not be construed as an admission that any of the information it contains constitutes prior art against the present patent application.

### SUMMARY OF THE INVENTION

There is provided, in accordance with an embodiment of the present invention, a method, including defining a set of protective actions, detecting, by a security server on a network, an incident including one or more alerts indicating malicious activity by one or more computing devices on the network, extracting, from the one or more alerts, a set of features indicating measurable characteristics of the incident, computing, based on the one or more alerts, respective counts for the features for the detected incident, computing, based on the features and their respective counts, a score indicating a magnitude of malicious activity for the detected incident, identifying a given feature having a highest impact on the score, selecting a given protective action based on the score, the identified feature and its respective count, and initiating the selected protective action with respect to at least some of the one or more computing devices.

In one embodiment, identifying a given feature having the highest impact on the score includes computing respective impact scores for each of the features, and identifying one or more of the features based on a comparison of the respective impact scores to a specified threshold, wherein selecting a given protective action includes selecting respective protective actions for the identified one or more features based on the score, the identified one or more features and their respective counts, and wherein initiating the selected protective action includes initiating the one or more respective protective actions.

In another embodiment, identifying a given feature having the highest impact on the score, includes computing respective impact scores for each of the features, ranking the features based on their respective ranking scores, and identifying one or more of the features whose respective impact scores meet a specified ranking condition, wherein selecting a given protective action includes selecting respective protective actions for the identified one or more features based on the score, the identified one or more features and their respective counts, and wherein initiating the selected protective action includes initiating the one or more respective protective actions.

In an additional embodiment, the protective actions include explanation strings, wherein selecting a given protective action includes selecting a given explanation string, and wherein initiating the protective action includes presenting, on a display, the given explanation string.

In some embodiments, initiating the given protective action includes presenting, on the display, a maliciousness indicator for the given explanation string.

In a further embodiment, the method further includes computing recency and frequency attributes for the one or more alerts, and presenting, on the display, context information for the one or more alerts based on the computed recency and frequency attributes.

In a supplemental embodiment, detecting the incident includes receiving a set of alerts including respective times and artifacts, and analyzing the times and the artifacts so as to group a subset of the alerts into the incident, wherein the subset includes the one or more alerts.

In some embodiments, receiving a given alert includes receiving the given alert from a given computing device or from a network management device managing the network.

In one embodiment, a given protective action includes isolating a given computing device.

In another embodiment, a given protective action includes restricting a user accessing a given computing device.

In an additional embodiment, a given protective action includes terminating a process executing on a given computing device.

In a further embodiment, a given protective action includes quarantining a file.

In a supplemental embodiment, one or more of the computing devices communicate with a server, and a given protective action includes isolating the server.

In one embodiment, the method further includes defining selection criteria for each of the protective actions, and selecting the given protective action includes comparing the score, the identified feature and its respective count to the selection criteria of the protective action, and detecting a match to the selection criteria for the given protective action.

In another embodiment, the features include incident features, and the method further includes extracting a set of alert features from the one or more alerts, and a given incident alert includes a count of the one or more alerts having common alert features.

In an additional embodiment, a given feature includes a given alert.

In a further embodiment, computing the score includes applying a machine learning model to the features and their respective counts.

In some embodiments, identifying the given feature having a highest impact on the score includes performing a Shapley Additive Explanation analysis on the features.

There is also provided, in accordance with an embodiment of the present invention, an apparatus, including a memory, and a processor configured to store, in the memory, a set of protective actions, to detect, on a network, an incident including one or more alerts indicating malicious activity by one or more computing devices on the network, to extract, from the one or more alerts, a set of features indicating measurable characteristics of the incident, to compute, based on the one or more alerts, respective counts for the features for the detected incident, to compute, based on the features and their respective counts, a score indicating a magnitude of malicious activity for the detected incident, to identify a given feature having a highest impact on the score, to select a given protective action based on the score, the identified feature and its respective count, and to initiate the selected protective action with respect to at least some of the one or more computing devices.

There is additionally provided, in accordance with an embodiment of the present invention, a computer software product for protecting a computing device, which includes a processor and a memory and is coupled to a storage device storing a set of one or more files, the computer software product including a non-transitory computer-readable medium, in which program instructions are stored, which instructions, when read by a computer, cause the computer to define a set of protective actions, to detect, on a network, an incident including one or more alerts indicating malicious activity by one or more computing devices on the network, to extract, from the one or more alerts, a set of features indicating measurable characteristics of the incident, to compute, based on the one or more alerts, respective counts for the features for the detected incident, to compute, based on the features and their respective counts, a score indicating a magnitude of malicious activity for the detected incident, to identify a given feature having a highest impact on the score, to select a given protective action based on the score, the identified feature and its respective count, and to initiate the selected protective action with respect to at least some of the one or more computing devices.

### BRIEF DESCRIPTION OF THE DRAWINGS

The disclosure is herein described, by way of example only, with reference to the accompanying drawings, wherein:

FIG. 1 is a block diagram showing an example of a computing facility comprising a security server that is configured to initiate a protective action in response to detecting to a security incident involving one or more host computers in the facility, in accordance with an embodiment of the present invention;

FIG. 2 is a block diagram showing an example of a configuration of a given host computer, in accordance with an embodiment of the present invention;

FIG. 3 is a block diagram that shows an example of a configuration of the security server, in accordance with an embodiment of the present invention;

FIG. 4 is a flow diagram that schematically illustrates a method of selecting and performing a protective action in response to detecting a security incident, in accordance with an embodiment of the present invention; and

FIG. 5 is an example of a given protective action comprising an explanation window presented to a security operations center (SOC) analyst, in accordance with an embodiment of the present invention.

### DETAILED DESCRIPTION OF EMBODIMENTS

Embodiments of the present invention provide methods and systems for a security server to protect host computers (also referred to herein as computing devices) coupled to a data network. As described hereinbelow, a set of protective actions are defined, and selection criteria for the protective actions are defined. Upon the security server detecting an incident comprising one or more alerts indicating malicious activity by one or more computing devices on the network, a set of features indicating measurable characteristics of the incident are extracted from the alerts, and based on the one or more alerts, respective counts for the features for the detected incident are computed.

Based on the features and their respective counts, a score indicating a magnitude of malicious activity for the detected incident, and a given feature having a highest (i.e., greatest) impact on the score is identified. A given protective action is selected based on a tuple comprising the score, the identified feature and its respective count. To select the given protective action, the score, the identified feature and its respective count can be compared to the selection criteria (i.e., for the protective actions), and detect that the selection criteria for the given protective action matches the computed score, the identified feature and its respective count. Finally, the selected protective action can be initiated with respect to at least some of the one or more computing devices.

In a first embodiment, a given protective action may comprise an automated system operation such as isolating one or more host computers, quarantining one or more files stored on the network or disabling a user. In a second embodiment, a protective action may comprise presenting, on a display, a text string explaining the selected feature, which can help explain the incident to a security operations center (SOC) analyst, thereby enabling the analyst to formulate a response to the incident. In the second embodiment, context information for the alerts and/or the incident may also be computed and presented to the SOC analyst, as described hereinbelow.

In some embodiments, selecting and initiating the given protective action may comprise ranking the features as to their impact on the score and initiating protective actions for the highest ranked (e.g., the top five) features. By using a ranking system to select and initiate protective actions, systems implementing embodiments of the present invention can optimize responses to security incidents comprising one or more alerts, and can also assist in explaining the incidents to SOC analysts.

### SYSTEM DESCRIPTION

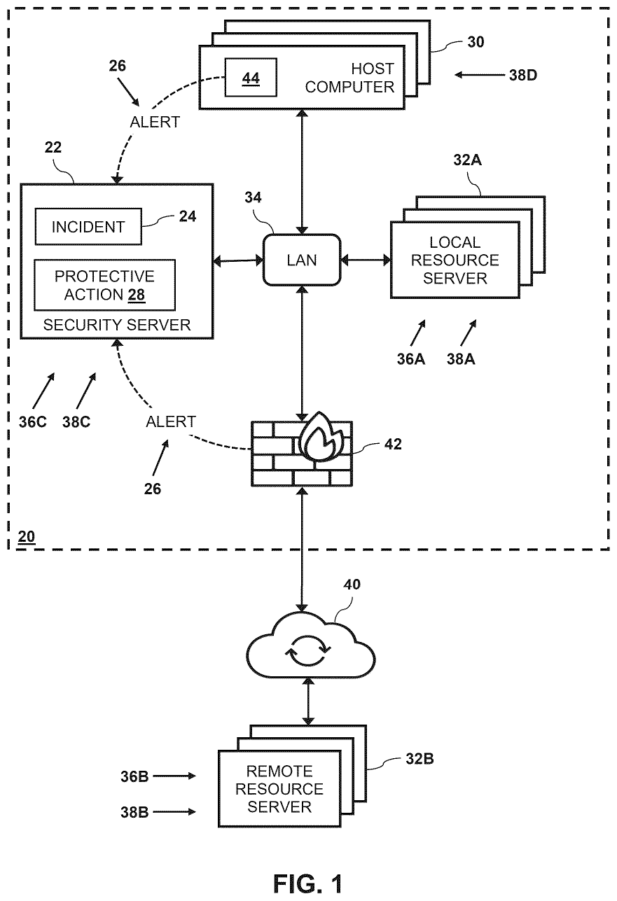

FIG. 1 is a block diagrams that shows an example of a computing facility 20 comprising a security server 22 that can detect an incident record 24 (also referred to herein simply as incident 24) comprising one or more alerts 26 indicating suspected malicious activity, and can initiate a protective action 28 in response to the detection, in accordance with an embodiment of the present invention.

In the configuration shown in FIG. 1, security server 22 can communicate with one or more host computers 30 and one or more resource servers 32 via a data network such as local area network (LAN) 34. In embodiments herein incidents 24 comprise one or more alerts 26 indicating suspected malicious activity initiated by one or more host computers 30 and/or one or more resource servers 32.

In some embodiments, resource servers 32 comprise (i.e., can be referenced by or accessed via) respective domains 36, and the resource servers and host computers 30 comprise respective Internet Protocol (IP) addresses 38. Resource servers can host, e.g., for computers 30, one or more web-based applications and/or provide network services such as database management systems.

LAN 34 is also coupled to a network management device such as a firewall 42 that controls and monitors traffic between LAN 34 and a public network such as Internet 40, and can generate one or more alerts 26 upon detecting malicious traffic on LAN 34 and/or received from Internet 40. One example of firewall 42 is a PA-3250 NEXT GENERATION FIREWALL™ produced by PALO ALTO NETWORKS, INC. of 3000 Tannery Way, Santa Clara, CA 95054 USA.

In embodiments described herein, resource servers 32, domains 36 and IP addresses 38 can be differentiated by appending a letter to the identifying numeral, so that the resource servers comprise local resource servers 32A and remote resource servers 32B, the domains comprise domains 36A-36C, and the IP addresses comprise IP addresses 38A-38D. In the configuration shown in FIG. 1:
Resource servers 32A are coupled to LAN 34 and comprise respective domains 36A and IP addresses 38A.
Resource servers 32B are accessible to host computers 30 via Internet 40 and comprise respective domains 36B and IP addresses 38A.
Security server 22 comprises domain 36C and IP address 38C.
Host computers 30 comprise respective IP addresses 38D.

In some embodiments, one or more host computers 30 may execute respective instances of an endpoint agent 44, and the endpoint agent executing on a given host computer can convey one or more alerts 26 in response to detecting malicious activity on the given host computer. One example of a given endpoint agent 44 is CORTEX XSOAR™ (produced by PALO ALTO NETWORKS INC.). Host computers 30 and resource servers 32 may be collectively referred to herein simply as computing devices.

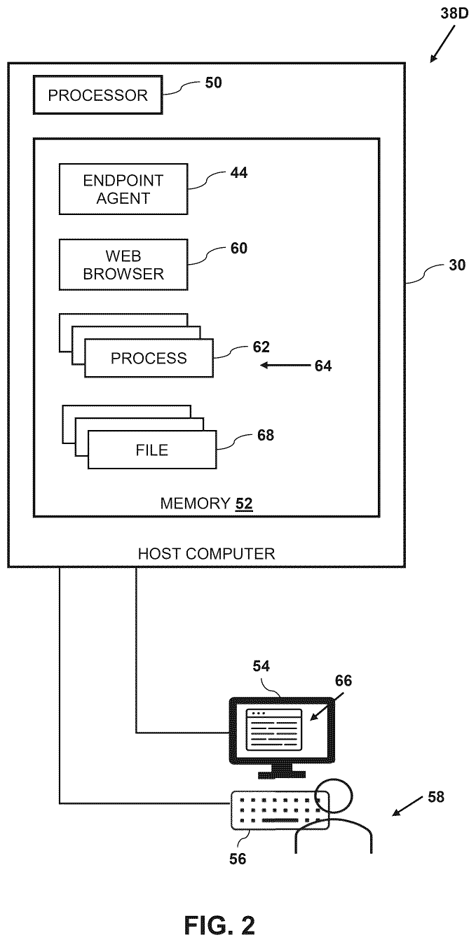

FIG. 2 is a block diagram showing an example of hardware and software components of a given host computer 30, in accordance with an embodiment of the present invention. The given host computer may comprise a host processor 50 and a host memory 52. In the configuration shown in FIG. 2, the given host computer may also comprise a display 54 and an input device such as a keyboard 56 that a user 58 can use in order to interact with the given host computer. In embodiments where user 58 comprises an SOC analyst, the user may be referred to herein as SOC analyst 58.

Memory 52 may comprise endpoint agent 44, a web browser 60 (i.e., a software application, a plurality of processes 62 that execute on processor 50, and a set of files 68 (e.g., data or executable files). While the configuration in FIG. 2 shows the given host computer storing

file 68, storing file 68 on any computing device coupled to LAN 34 is considered to be within the spirit and scope of the present invention.

Each process 62 comprises a respective process identifier (IDs) 64. In some embodiments, a given process identifier 64 may comprise a process hash for a given process 62.

An example of web browser 60 is the CHROME™ browser produced by ALPHABET INC., 1600 Amphitheatre Parkway, Mountain View, CA 94043, USA. When executing on processor 50, browser 60 can present a rendering 66 on display 54 in response to communicating with one or more resource servers 32.

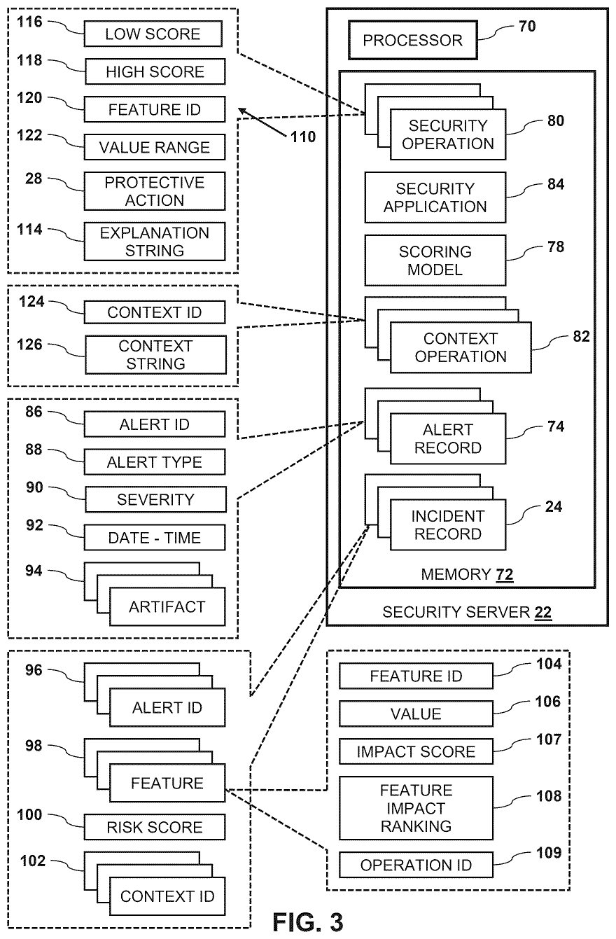

FIG. 3 is a block diagram that shows hardware and software components of security server 22, in accordance with an embodiment of the present invention. In the configuration shown in FIG. 3, security server 22 comprises a security processor 70 and a security memory 72 that comprises a set of alert records 74, a set of incident records 24 (, a scoring model 78, a set of security operations 80, a set of context operations 82, and a security application 84. In some embodiments, security application 84 may comprise a web-based software application processor 50 and/or processor 70 can execute so as to perform embodiments described hereinbelow.

Each alert record 74 corresponds to a given alert 26 and can store information such as:
A unique alert ID 86 for the given alert.
An alert type 88 indicating a category for the given alert. Examples of alert types 88 include, but are not limited to, a suspicious process 62, a suspicious file 68, a suspicious domain 36 and a suspicious IP address 38.
An alert severity 90 indicating a risk level (e.g., low, medium, high) for the given alert.
A date and time 92 indicating when the alert was generated.
A set of artifacts 94 that comprise descriptive attributes in the given alert. Examples of artifacts 94 include, but are not limited to:
   A first IP address 38 referencing a first computing device that conveyed a transmission (not shown).
   A second IP address 38 referencing a second computing device that received the transmission.
   A given process ID 64.
   A given domain 36 for a given resource server 32 accessed by a given computing device.
   A given file 68 accessed by a given computing device.
   A given user 58 operating a given host computer 30.

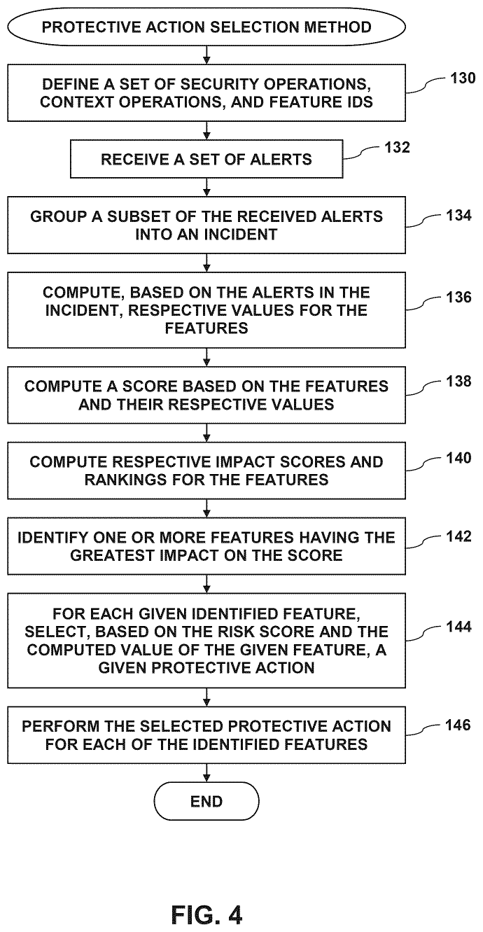

As described in the description referencing FIG. 4 hereinbelow, security application 84 is configured to group a plurality of alerts 26 into one or more incidents 24 that can be respectively stored in incident records 24. Each incident record 24 can store information such as:
One or more alert IDs 96 referencing the one or more alerts (i.e., by respectively referencing one or more alert IDs 86.
A set of features 98 that are described hereinbelow.
A risk score 100 that indicates a suspected magnitude of malicious activity for the given incident. As described hereinbelow, scoring model 78 can compute risk score 100 based on features 98. Further details of incident scores such as risk score 100 are described in U.S. Patent Application Publication Ser. No. 17/571,558, whose disclosure is incorporated herein by reference.
One or more context IDs 102. As described hereinbelow, security application 84 can populate context IDs 102 so as to present, to an SOC analyst on display 54, context information on the given incident.

Each feature 98 comprises a measurable characteristic of one or more alerts 26, and can include information such as:
A feature ID 104 (also referred to herein as feature name 104) indicating a specific characteristic. Specific characteristics are described hereinbelow.
A value 106 for the specific characteristic referenced by feature ID 104. Values 106 are described hereinbelow.
An impact score 107. In embodiments described herein, security application 84 can use scoring model 78 to compute risk score 100 for a given incident 24 based on features 98 extracted from the alerts in the given incident. In some embodiments, scoring model 78 comprises a machine learning model. Upon computing risk score 100, security application 84 can perform an analysis, such as a Shapley Additive Explanation (SHAP) analysis so as to compute respective impact scores 107 for the features used to compute the risk score, wherein the impact score for a given feature 98 indicates an impact of the given feature on the computed risk score.
A feature impact ranking 108 (also referred to herein simply as ranking 108). In some embodiments, for a given risk score 100 computed based on features 98, security application 84 can generate rankings 108 for features 98 based on their respective impact scores 107.
An operation ID 109 referencing a given security operation record 80. Assigning operation ID 109 to a given feature 98 is described in the description referencing FIG. 4 hereinbelow.

In a first feature embodiment, a given feature 98 may comprise an indication as to whether or not there was a specific alert in a given incident. For example, a given feature in the first feature embodiment may indicate whether or not a given endpoint agent 44 detected and prevented suspicious activity on a given host computer 30. In this example, security application 84 can store “0” to value 106 for the given feature if no endpoint agents 44 detected suspicious activity on any host computer 30, and store “1” to value 106 for the given feature if a given endpoint agent 44 detected and prevented suspicious activity on a given host computer 30.

In a second feature embodiment, a given feature 98 can be a computation based on multiple alerts. For example, in a given incident 24, a given feature in the second feature embodiment may comprise computing a count of how many different alert types 88 security application 84 detected in the alerts of the given incident.

In a third feature embodiment, a given feature 98 can be based on a historical analysis of alerts 26. For example, for a given incident 24 comprising a set of alerts 26 having respective alert types 88, a given feature may comprise whether or not a given alert type 88 or a combination of the alerts (i.e., in this and other incidents 24) is “common” (i.e., was detected X times in the past Y days).

In the configuration shown in FIG. 3, each given security operation 80 comprises selection criteria 110, a given protective action 28 and an explanation string 114. In embodiments described herein, selection criteria 110 for each given security operation 80 comprises a low score 116, a high score 118, a feature ID 120 (i.e., a feature name) and a value range 122. Value range 122 may comprise a single value (e.g., 0 or 1) or a range of values (e.g., greater than 1). Use of selection criteria 110 is described in the description referencing FIG. 4 hereinbelow. Examples of protective actions 28, include but are not limited to:
Isolate a given host computer 30.
Terminate a given process 62 executing on a given host computer 30.
Quarantine a given file 68.
Isolate a given server 32 by restricting access to a given domain 36 or a given IP address 38.
Restrict access by a given user 58 to host computers 30. For example, a given protective action may logout, disable or suspend a login account for a given user 58, or require multi-factor authentication for the given user.

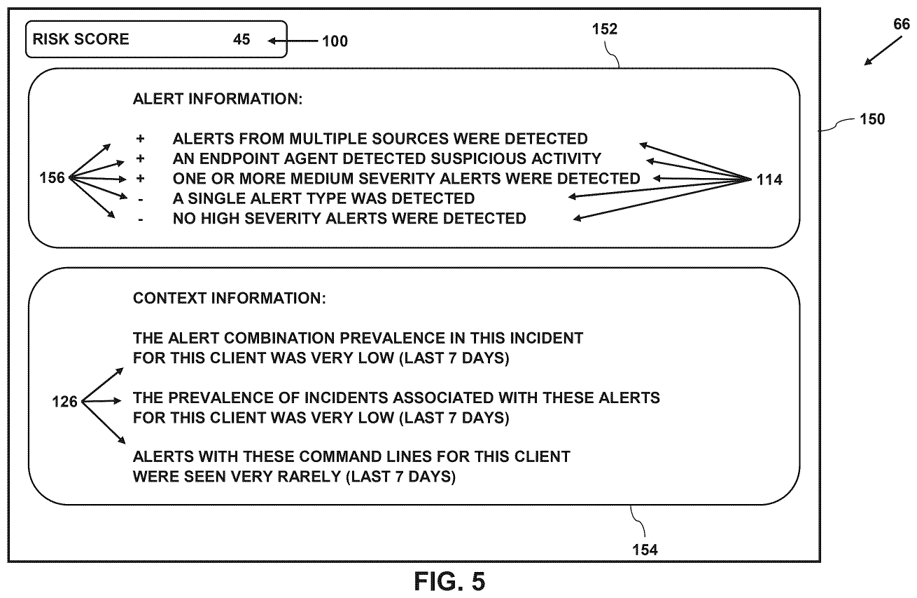

Explanation strings 114 provide different explanations for each combination of selection criteria 110 (i.e., different combinations of low score 116, high score 118, feature ID 120 and value range 122. Examples of explanation 114 are shown in FIG. 5 as described hereinbelow.

In the configuration shown in FIG. 3, each context operation 82 comprises a context ID 124 and a context string 126, which are described in the description referencing FIGS. 4 and 5 hereinbelow.

Processors 50 and 70 comprise general-purpose central processing units (CPU) or special-purpose embedded processors, which are programmed in software or firmware to carry out the functions described herein. This software may be downloaded to security server 22 and host computers 30 in electronic form, over a network, for example. Additionally or alternatively, the software may be stored on tangible, non-transitory computer-readable media, such as optical, magnetic, or electronic memory media. Further additionally or alternatively, at least some of the functions of processors 50 and 70 may be carried out by hard-wired or programmable digital logic circuits.

Examples of memories 52 and 72 include dynamic random-access memories, non-volatile random-access memories, hard disk drives and solid-state disk drives.

In some embodiments, tasks described herein performed by processor 70 may be split among multiple physical and/or virtual computing devices. In other embodiments, these tasks may be performed in a managed cloud service.

### FEATURE-BASED PROTECTIVE ACTION SELECTION

FIG. 4 is a flow diagram that schematically illustrates a method of selecting and performing a given protective action 28 in response to detecting a given security incident 24, in accordance with an embodiment of the present invention.

In step 130, SOC analyst 58 accesses security application 84 via web browser 60 so as to define security operations 80, context operations 82, and feature IDs 104.

In step 132, security application 84 receives a set of alerts 26. Upon receiving each given alert 26, security application 84 can add a new alert record 74, generate and store, to the new alert record, a new alert ID 86, and populate, in the new alert record using information extracted from the received alert, alert type 88, severity 90, date and time 92 and one or more artifacts 94.

In step 134, security application 84 groups a subset of the received alerts into a new incident 24. In embodiments herein, grouping the subset of the received alerts into the new incident may also be referred to as identifying the new incident. The following are examples of how security application 84 can identify the new incident by analyzing alert records 74.

In a first example, security application 84 can identify a given alert record 74 comprising unique artifacts 94 within a specified time window. For example, by analyzing alert records 74, security application 84 can detect that only a single alert 26 within a four-hour time period was for a single access (i.e., by a single host computer 30) to a given domain 36 suspected of being malicious.

In a second example, security application 84 can identify multiple record 74 comprising identical artifacts 94 within a specified time window. For example, by analyzing alert records 74, security application 84 can detect, within a four-hour time-period, multiple alerts 26 for multiple accesses (i.e., by one or more host computers 30) to a given domain 36 suspected of being malicious.

Upon detecting the new incident, security application 84 can add a new incident record 24, and populate, in the new incident record, alert IDs 96 and feature IDs 104 with information extracted from the grouped alerts in the new incident.

In step 136, security application 84 extracts features 98 for the new incident by computing, based on the alerts in the new incident, respective values 106 for features IDs 104, and storing feature IDs 104 and their respective computed values to features 98 in the new incident record). As described supra, a given value 106 may comprise an indication as to whether or not there was a specific alert 26 in the given incident (i.e., a “1” or a “0”), or a computation based on multiple alerts 26 in the given incident.

In step 138, security application 84 computes, based on features 98 (i.e., feature IDs 104 and their respective values 106), risk score 100, and stores the computed risk score to the new incident record.

In step 140, security application 84 computes respective impact scores 107 and rankings 117 for features 98. As described supra, security application 84 can compute impact score 107 by computing respective SHAP values for features 98.

In step 142, security application 84 identifies one or more feature 98 (i.e., the feature ID 104 and the value 106 for the given feature) having the greatest impact on the computed risk score for the incident. In one embodiment, security application 84 can identify the one or more feature having the greatest impact by identifying the top N (e.g., 3, 4 or 5) features 98 based on their respective impact scores 107 (i.e., by comparing rankings 108 to a specified ranking condition). In another embodiment, security application 84 can identify the one or more feature having the greatest impact by identifying any features 98 whose respective impact scores 107 exceed a specified threshold (i.e., if higher impact scores indicate higher impact) or are below a specified threshold (i.e., if lower impact scores indicate higher impact).

In step 144, for each identified feature 98, security application 84 selects a given protective action 28 in a given security operation 80, and stores, to operation ID 109 (i.e., in the given feature), a reference to the given security operation.

To select the given protective action for a given identified feature, security application can compare risk score 100, feature ID 104 (i.e., for the given feature) and value 106 (i.e., for the given feature) to selection criteria 110 in security operations so as identify a given protective action 28 in a given security operation 80 whose selection criteria 110 matches risk score 100, feature ID 104 and value 106 (i.e., risk score 100 for the incident is greater than or equal to low score 116 in the given security operation, risk score 100 for the incident is less than or equal to high score 118 in the given security operation, feature ID 104 in the given identified feature matches feature ID 120 in the given security operation, and value 106 in the given identified feature is within value range 122 in the given security operation).

As described supra, security application 84 can select a given security operation 80 based on a combination of risk score 100 for a given incident 24 and the feature ID 104 and the value 106 for a given feature 98 extracted from the incident. In embodiments described herein, different combinations of risk scores, feature IDs 104 and 120 will result in different security operations 80 being selected by security application 84.

For example, if a given feature 98 (referenced by a given feature ID 104) indicates how many different alert types 88 are in a given incident 24, then:
In a first given security operation 80, feature ID 120 references the given feature ID 104, value range 122 is “0” (i.e., a single value), and explanation string 114 is “A single alert type was detected”.
In a second given security operation 80, feature ID 120 references the given feature ID 104, value range 122 is “>0” (i.e. any value greater than 0), and explanation string 114 is “Multiple alert types were detected”.
   These security operations 80 may also comprise different respective protective actions 28.

Finally, in step 146, security application 84 performs the selected protective action 28 for each of the identified features 98, and the method ends. As described supra, examples of protective actions 28 include, but are not limited to, isolating a given host computer 30, terminating a given process 62 or quarantining a given file 68.

In one embodiment, performing the protective action in a given security operation 80 comprise presenting, in rendering 66 on display 54, the explanation string in the given security operation.

In another embodiment, performing a given protective action in response to identifying the incident may comprise computing recency and frequency attributes for the alerts in the incident over a specific time period (e.g., the last seven days), selecting, based on the computed recency and frequency attributes, one or more context IDs 124 referencing respective context strings 126, storing the one or more identified context IDs to respective one or more context IDs in the new incident record, and presenting, in rendering 66 on display 54, the one or more context strings 126 referenced by the one or more context IDs 124.

FIG. 5 is an example of the given protective action comprising a given rendering 66, in accordance with an embodiment of the present invention. In the example shown in FIG. 5:
Rendering 66 comprises an explanation window 150 that presents risk score 100, an alert section 152 and a context section 154.
Alert section 152 comprises the explanation strings referenced by the operation IDs in the features whose respective rankings 108 match a specified ranking condition (e.g., a specific number of highest ranked features 98). In some embodiments, for each explanation string 114 corresponding to a given feature 98, security application 84 can present, in alert section 152, a corresponding maliciousness indicator 156 indicating an impact of given feature on score 100. In the example shown in in FIG. 5, the alert icon “+” indicates that the given feature increased score 100 and the alert icon “−” indicates that the given feature decreased score 100.
Context section 154 comprises the context strings referenced by the context IDs in a given incident record 24.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method, comprising:
obtaining, by a security server from one or more non-transitory memories, a plurality of electronically stored records generated by one or more computers, the plurality of records being indicative of one or more alerts raised in response to a computer security incident;
extracting, by at least one processor of the security server from the plurality of records, data informative of one or more of: (i) presence or absence of specific alert types, (ii) a number of different alert types raised in response to the incident, and (iii) a number of times a given alert type or combination of alert types was raised in a specified previous time period;
executing, by the at least one processor, a scoring model on the extracted data to generate a maliciousness score for the incident;
computing, by the at least one processor, respective contribution values for a plurality of portions of the extracted data, each contribution value indicating a contribution of a respective portion to the maliciousness score, and selecting a portion having a greatest contribution value;
selecting, by the security server based on results of the executing and the computing, a protective action to initiate in response to the incident; and
initiating the selected protective action by at least one of isolating a computing device, terminating a process, quarantining a file, or restricting user access.

2. The method of claim 1, wherein the plurality of electronically stored records include, for each alert, at least one of an alert type, an alert severity, a date and time, or one or more artifacts.

3. The method of claim 2, wherein the one or more artifacts comprise at least one of: a source Internet Protocol (IP) address, a destination IP address, a process identifier, a domain, a file, or a user identifier.

4. The method of claim 1, wherein executing the scoring model comprises applying a machine learning model to the extracted data.

5. The method of claim 1, wherein computing the respective contribution values comprises performing an explanation analysis that attributes contributions of portions of the extracted data to the maliciousness score.

6. The method of claim 5, wherein the explanation analysis comprises a Shapley Additive Explanation (SHAP) analysis.

7. The method of claim 1, wherein selecting the protective action comprises applying selection criteria that include (i) a maliciousness score range and (ii) at least one condition on the extracted data.

8. A security system, comprising:
one or more non-transitory memories configured to store a plurality of electronically stored records generated by one or more computers, the plurality of records being indicative of one or more alerts raised in response to a computer security incident; and
at least one processor configured to:
extract, from the plurality of electronically stored records, data informative of one or more of: (i) presence or absence of specific alert types, (ii) a number of different alert types raised in response to the incident, and (iii) a number of times a given alert type or combination of alert types was raised in a specified previous time period;
execute a scoring model on the extracted data to generate a maliciousness score for the incident;
compute respective contribution values for a plurality of portions of the extracted data, each contribution value indicating a contribution of a respective portion to the maliciousness score, and select a portion having a greatest contribution value;
select a protective action to initiate in response to the incident based on results of the executed scoring model and the computed respective contribution values; and
initiate the selected protective action by at least one of isolating a computing device, terminating a process, quarantining a file, or restricting user access.

9. The security system of claim 8, wherein the plurality of electronically stored records include, for each alert, at least one of an alert type, an alert severity, a date and time, or one or more artifacts.

10. The security system of claim 9, wherein the one or more artifacts comprise at least one of: a source Internet Protocol (IP) address, a destination IP address, a process identifier, a domain, a file, or a user identifier.

11. The security system of claim 8, wherein the at least one processor is configured to execute the scoring model by applying a machine learning model to the extracted data.

12. The security system of claim 8, wherein the at least one processor is configured to compute the respective contribution values by performing an explanation analysis that attributes contributions of portions of the extracted data to the maliciousness score.

13. The security system of claim 12, wherein the explanation analysis comprises a Shapley Additive Explanation (SHAP) analysis.

14. The security system of claim 8, wherein the at least one processor is configured to select the protective action by applying selection criteria that include (i) a maliciousness score range and (ii) at least one condition on the extracted data.

15. A non-transitory computer-readable medium storing instructions that, when executed
by one or more processors of a security server, cause the security server to:
extract, from the plurality of electronically stored records, data informative of one or more of: (i) presence or absence of specific alert types, (ii) a number of different alert types raised in response to the incident, and (iii) a number of times a given alert type or combination of alert types was raised in a specified previous time period;
execute a scoring model on the extracted data to generate a maliciousness score for the incident;
compute respective contribution values for a plurality of portions of the extracted data, each contribution value indicating a contribution of a respective portion to the maliciousness score, and select a portion having a greatest contribution value;
select a protective action to initiate in response to the incident based on results of the executed scoring model and the computed respective contribution values; and
initiate the selected protective action by at least one of isolating a computing device, terminating a process, quarantining a file, or restricting user access.

16. The non-transitory computer-readable medium of claim 15, wherein the instructions, when executed, cause the security server to execute the scoring model by applying a machine learning model to the extracted data.

17. The non-transitory computer-readable medium of claim 15, wherein the instructions, when executed, cause the security server to compute the respective contribution values by performing an explanation analysis that attributes contributions of portions of the extracted data to the maliciousness score.

18. The non-transitory computer-readable medium of claim 17, wherein the explanation analysis comprises a Shapley Additive Explanation (SHAP) analysis.

19. The non-transitory computer-readable medium of claim 15, wherein the instructions, when executed, cause the security server to select the protective action by applying selection criteria that include (i) a maliciousness score range and (ii) at least one condition on the extracted data.

20. The non-transitory computer-readable medium of claim 15, wherein the instructions, when executed, cause the security server to store, in the one or more non-transitory memories, at least one of the maliciousness score or an identifier of the selected protective action in association with the incident.
